(19) United States
(12) Patent Application Publication
(10) Pub. No.: US 2017/0277003 A1
(43) Pub. Date: Sep. 28, 2017

(54) PHASE MODULATOR FOR HOLOGRAPHIC SEE THROUGH DISPLAY

(71) Applicant: Hong Kong Applied Science and Technology Research Institute Company Limited, Hong Kong (HK)

(72) Inventor: Xiuling ZHU, Hong Kong (HK)

(21) Appl. No.: 15/077,921

(22) Filed: Mar. 23, 2016

(51) Int. Cl. G02F 1/1337; G02F 1/1334; G02B 27/01; G02F 1/1343

(52) U.S. Cl. CPC G02F 1/133753; G02F 1/134309; G02F 1/1337; G02F 1/1334; G02F 1/133788; G02B 27/0101; G02F 2201/123; G02F 2001/133757

(57) ABSTRACT

The presently claimed invention provides a phase modulator for a see-through display, and the corresponding fabrication methods. The phase modulator comprises a liquid crystal layer having at least two types of domains including a first domain having a first refractive index and a second domain having a second refractive index. The phase modulator is able to increase field of view without inducing the problem of the fringe field effect between two adjacent pixels.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to a see through display, more particularly, the present invention relates to a new phase modulator used for holographic see through display.

### BACKGROUND

Nowadays, head mount display (HMD) and head up display (HUD) being essentially wearable intelligent devices, or other kind of displays are capable of displaying images, inter alia, on glasses lenses or screens oriented in front of a user's eyes, among other things. More and more HMDs adopt see-through display to allow full or partial views of the user's surroundings. For instance, GOOGLE GLASS® is one HMD device that resembles a pair of glasses with a computing device built directly into the frame, and includes an optical structure to direct visible light into the eye of a user to display a variety of information. HMD devices, such as GOOGLE GLASS®, may provide users with a wearable computing device capable of providing visible overlays while still allowing the user to view his or her surroundings. HUD are systems which also adopts see through display onto which images could be projected such that it allows the viewer to maintain a posture in which the gaze is directed forward rather than downward to a display or instrument panel. Head-up displays are used in various environments such as motor vehicles, aircraft, helmets and other situations in which it is important that the viewer not divert his gaze. Therefore, the use of HUD could prevent a driver from taking his eyes off the road, i.e., reducing distraction for safe driving, and could reduce eye strain for comfortable driving.

Currently, amplitude-modulated display technologies are commonly used for the see-through display, e.g., Thin Film Transistor (TFT) Liquid Crystal Display (LCD)+ Light Emitting Diode (LED) backlight (Dominant technology), Digital Light Processing (DLP) projection or Liquid Crystal on Silicon (LCoS) projection (Emerging technologies). However, for Amplitude-modulated display, since there is always very a small image area (always <10%) to be used for display, most light is absorbed and creates heat for application in large Augmented Reality Head-up Display (AR-HUD) and large space is required for heat dissipation. Therefore, the light efficiency is very low, i.e., less than 10%. To solve such a problem, Phase only holographic projection display is an alternative solution for the see-through display. Holographic projection steers the coherent light to where an image needs to be displayed and in principle, no much light lost, just energy redirection. Therefore, the light efficiency could be increased to more than 90%.

However, challenges exist for LCoS phase modulator for holographic projection display. For example, the small diffractive field-of-view (FOV) is limited by the phase modulator's pixel size. FIG. 1A shows the structure of the LCoS phase modulator comprises glass substrate, transparent electrode, liquid crystal layer, pixel reflective electrode, and silicon substrate from top to bottom, wherein pixel reflective electrodes represent for multiple pixels for the display. According to FIG. 1B, diffractive angle θ=sin−1[λ/(2*Pitch)]. Normally, the pixel size of current LCoS phase modulator is between 6.4-32 m, and the diffractive FOV is less than 6 degree. In order to increase the diffractive FOV, the conventional solution is to further reduce the pixel size. However, due to the fringe field effect between two small adjacent pixels, if the pixel size is further decreased, the diffraction contrast and efficiency will be also decreased.

There is a need in the art to have a phase modulator for see-through display providing a large field of view without inducing the problem of the fringe field effect between two adjacent pixels.

### SUMMARY OF THE INVENTION

Accordingly, the presently claimed invention provides a phase modulator for see-through display providing a large field of view without inducing the problem of the fringe field effect between two adjacent pixels.

In accordance to an embodiment of the presently claimed invention, a phase modulator for a display, comprises: a liquid crystal layer; an electrode layer disposed on a first side of the liquid crystal layer for allowing light to pass through; and a plurality of pixel electrodes disposed on a second side of the liquid crystal layer and being operable with the electrode layer for supplying electric potential across the liquid crystal layer; wherein on each of the pixel electrodes, the liquid crystal layer comprises at least two types of domains including a first domain having a first refractive index and a second domain having a second refractive index; and wherein the first reflective index is different from the second reflective index.

Preferably, the first domain of the liquid crystal layer comprises aligned liquid crystal molecules, and the second domain of the liquid crystal layer comprises non-aligned liquid crystal molecules.

Preferably, the phase modulator further comprises an alignment layer located on the pixel electrodes and/or the electrode layer for forming the aligned liquid crystal molecules.

Preferably, the first domain of the liquid crystal layer comprises aligned liquid crystal molecules having a first orientation, and the second domain of the liquid crystal layer comprises aligned liquid crystal molecules having a second orientation, wherein the first orientation is different from the second orientation.

Preferably, the phase modulator further comprises an alignment layer located between the pixel electrodes and the liquid crystal layer, wherein the alignment layer comprises two different alignment directions on each of the pixel electrodes for forming the first domain of the liquid crystal layer and the second domain of the liquid crystal layer.

Preferably, the phase modulator further comprises an alignment layer located between the electrode layer and the liquid crystal layer, wherein the alignment layer comprises two different alignment directions for forming the first domain of the liquid crystal layer and the second domain of the liquid crystal layer.

Preferably, the phase modulator further comprises a polymer material penetrated into the liquid crystal layer to improve thermal stability of the liquid crystal layer.

Preferably, the phase modulator further comprises a polymer material enclosing the alignment layer to improve thermal stability of the alignment layer.

Preferably, the pixel electrodes are addressable.

A further aspect of the present invention is to provide a method for fabricating the phase modulator.

In accordance to an embodiment of the presently claimed invention, the alignment layer is formed by steps of: coating photo-sensitive alignment material on each of the pixel electrodes; placing a photo mask on the alignment material; and illuminating the alignment material with UV light without shielding by the photo mask to form the alignment layer.

In accordance to an embodiment of the presently claimed invention, the alignment layer is formed by steps of: coating photo-sensitive alignment material on each of the pixel electrodes; placing a first photo mask on the alignment material; illuminating a first part of the alignment material with light having a first polarized direction, wherein the first part of the alignment material is not shielded by the first photo mask; placing a second photo mask on the alignment material; and illuminating a second part of the alignment material with light having a second polarized direction to form the alignment layer comprising two different alignment directions, wherein the second part of the alignment material is not shielded by the second photo mask.

In accordance to an embodiment of the presently claimed invention, the alignment layer is formed by steps of: coating photo-sensitive alignment material on each pixel electrode; placing a photo mask on the alignment material; illuminating a part of the alignment material with light, wherein the part of the alignment material is not shielded by the photo mask; forming the alignment layer from the alignment material after light illumination; illuminating the second part of the pixel electrode with a first wavelength UV light; filling in the liquid crystal layer between the opposing electrodes, the liquid crystal layer including liquid molecules, and monomers; and polymerizing the monomer with a second wavelength UV light.

### BRIEF DESCRIPTION OF THE DRAWINGS

Embodiments of the present invention are described in more detail hereinafter with reference to the drawings, in which:

FIG. 1A shows a structure of a LCoS phase modulator in the prior art;

FIG. 1B shows pixel electrodes for diffracting incident beam in the prior art;

FIG. 2A shows a pixel pattern of a LCoS Phase modulator in the prior art;

FIG. 2B shows same alignment direction of the liquid crystal molecules in the prior art;

FIG. 3 shows one pixel optically separated into several sub-pixels by non-aligned liquid crystal molecules according to an embodiment of the presently claimed invention;

FIGS. 4A-C illustrate a photo alignment process for optically separating one pixel into several sub-pixels according to an embodiment of the presently claimed invention;

FIG. 5 shows alignment domain configured to be different between two adjacent sub-pixels according to an embodiment of the presently claimed invention;

FIGS. 6A-C illustrate a photo alignment process for optically separating one pixel into several sub-pixels according to an embodiment of the presently claimed invention;

FIG. 7A shows a phase modulator having a liquid crystal layer incorporated with polymer networks according to an embodiment of the presently claimed invention; and

FIG. 7B shows a phase modulator having a polymer network formed on the alignment surface according to an embodiment of the presently claimed invention.

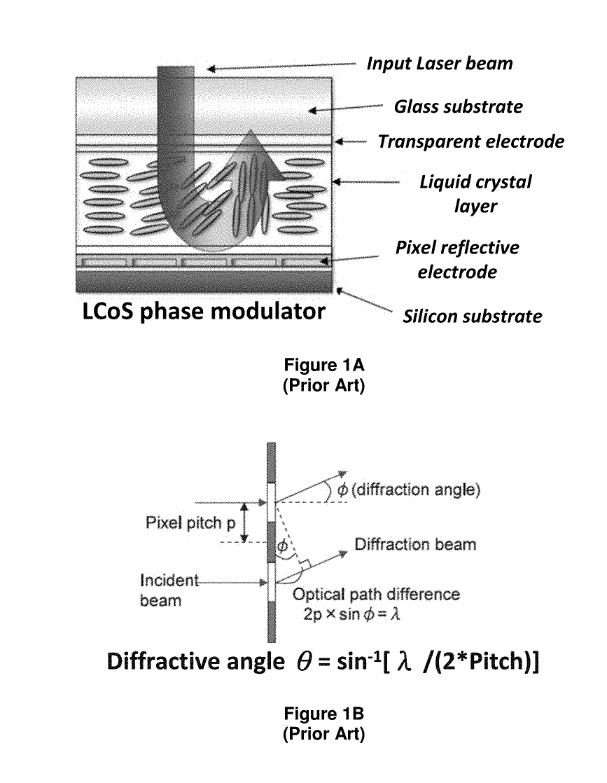

### DETAILED DESCRIPTION

In the following description, a LCoS phase modulator and the corresponding fabrication methods are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In the light of the foregoing background, it is an object of the present invention to provide a new LCoS phase modulator with particular structure to efficiently increase the diffraction of FOV so as to increase the FOV for information displayed.

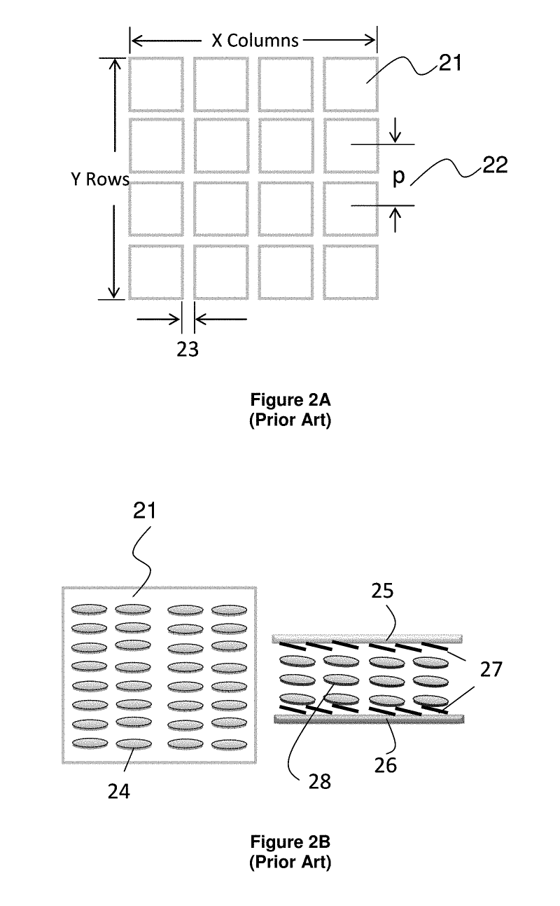

FIG. 2A shows a pixel pattern of the LCoS Phase modulator. There are Y rows and X columns pixel electrodes 21 arranged above the Silicon substrate of the modulator. The pixel electrodes are reflective and electrically isolated from each other. Diffraction spatial pitch P 22 is the distance between the centers of the two pixels. Inter pixel gap 23 exists between every two pixel electrodes 21. Normally in one pixel, the refractive index is the same with the same alignment direction as shown in FIG. 2B. There is a plurality of liquid crystal molecules 24 formed on the pixel electrode 21. In the pixel, there are a transparent electrode 25 and a reflective electrode 26. An alignment layer 27 is formed on the transparent electrode 25 and the reflective electrode 26. The liquid crystal molecules 24 are located between the transparent electrode 25 and the reflective electrode 26 to form a liquid crystal layer 28. As the liquid crystal molecules 24 are aligned in the same direction due to the alignment layers 27, the refractive index within the liquid crystal layer 28 is the same.

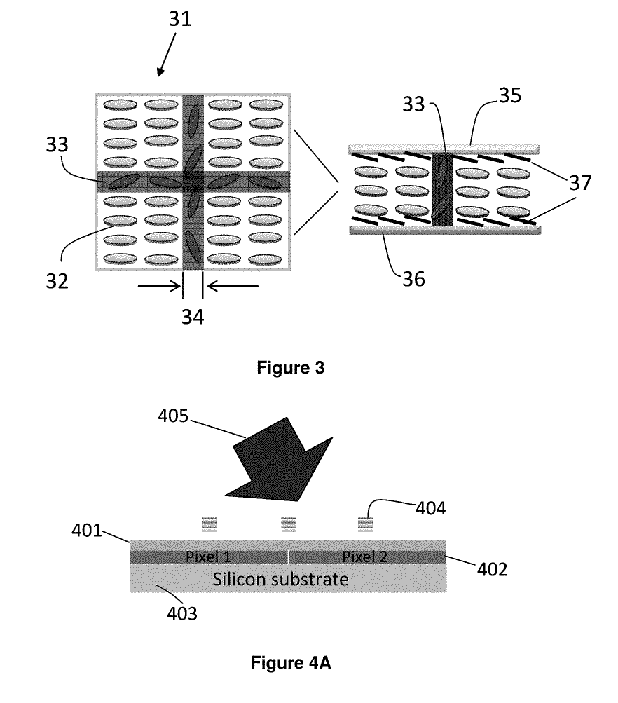

According to the present invention, in order to decrease the diffraction spatial pitch without affecting the efficiency, each pixel is divided into two or more sub-pixel areas that are optically isolated from each other. In one embodiment of the present invention, as shown in FIG. 3, one pixel 31 is optically separated into several sub-pixels 32, e.g., four sub-pixels, by non-aligned liquid crystal molecules 33. The sub-pixels 32 comprise the aligned liquid crystal molecules which can be horizontal aligned or vertical aligned. A gap 34 between two sub-pixels could be the same as the inter pixel gap. The non-aligned liquid crystal molecules 33 are formed on the transparent electrode 35 and the reflective electrode 36 without the presence of alignment layers 37. As such, new diffraction spatial pitch is reduced to p/2 and the diffraction of FOV can be increased about two times.

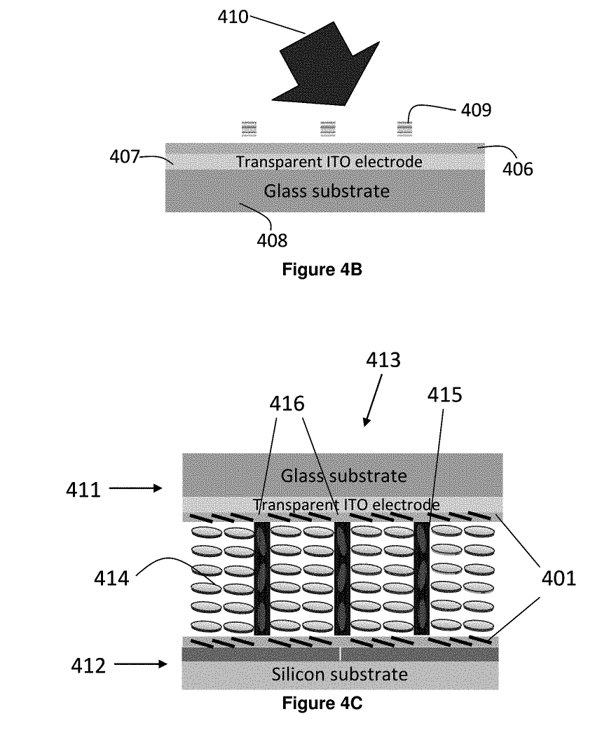

FIGS. 4A-C illustrate a photo alignment process for optically separating one pixel into several sub-pixels for the embodiment of FIG. 3. In FIG. 4A, an alignment layer 401 is arranged on multiple pixel electrodes 402 that are configured above a silicon substrate 403. Then, a photo mask 404 is configured on the alignment layer 401 at the silicon substrate side before 1st UV light 405 exposure along a specified direction. After the 1st UV light 405 exposure, the alignment layer 401 with liquid crystal molecules will be well aligned except the area under the mask. In FIG. 4B, an alignment layer 406 is arranged on a transparent ITO electrode 407 that is configured above a glass substrate 408. Then, a photo mask 409 is configured on the alignment layer 406 at the glass substrate side before the UV light 410 exposure in which the UV light 410 is same as the 1st UV light 405 in terms of wavelength and direction. After the 2nd UV light 410 exposure, the alignment layer 406 with liquid crystal molecules will be well aligned except the area under the mask. After the photo masks 404 and 409 are removed, in FIG. 4C, a silicon substrate portion 411 and a glass substrate portion 412, formed from the above steps, are assembled to form a phase modulator 413 wherein each pixel is separated into several sub-pixels 414 by non-aligned liquid crystal molecules 415 formed on the un-aligned areas 416 of the two alignment layers 401.

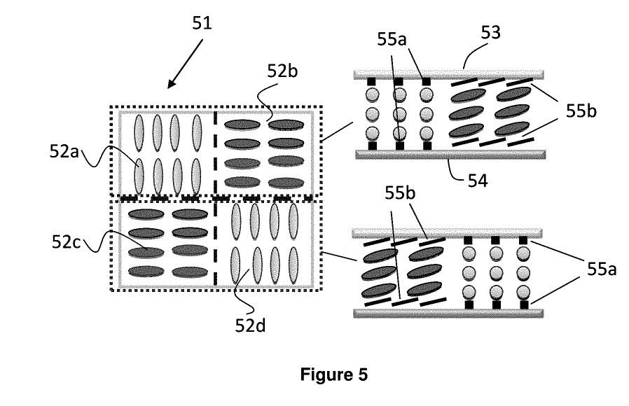

In an alternative embodiment of the present invention, as shown in FIG. 5, a pixel 51 is equally divided into four sub-pixels 52a, 52b, 52c, and 52d. The alignment domain of the liquid crystal molecules is configured to be different between two adjacent sub-pixels, such that the two adjacent sub-pixels are optically isolated to each other. For example, the sub-pixel 52a is optically different from sub-pixels 52b and 52c. Such configuration is achieved by forming two types of alignment layers 55a and 55b, having different orientations, on a transparent electrode 53 and a reflective electrode 54 of the pixel 51. The alignment layers 55a and 55b can be formed from AZO dye and their thickness can be in a range of several nanometers to hundreds of nanometers. The alignment layer 55a is assisted to form the sub-pixels 52a and 52d having liquid crystal molecules 57 aligned with a first orientation while the alignment layer 55b is assisted to form the sub-pixel 52b and 52c having liquid crystal molecules aligned with a second orientation. As the first orientation of the liquid crystal molecules 57 is different from the second orientation of the liquid crystal molecules 57, the refractive index of the sub-pixel 52a is different from that of the sub-pixels 52b and 52c. Under such arrangement, new diffraction spatial pitch is reduced to p/2 and the diffraction FOV can be increased about two times.

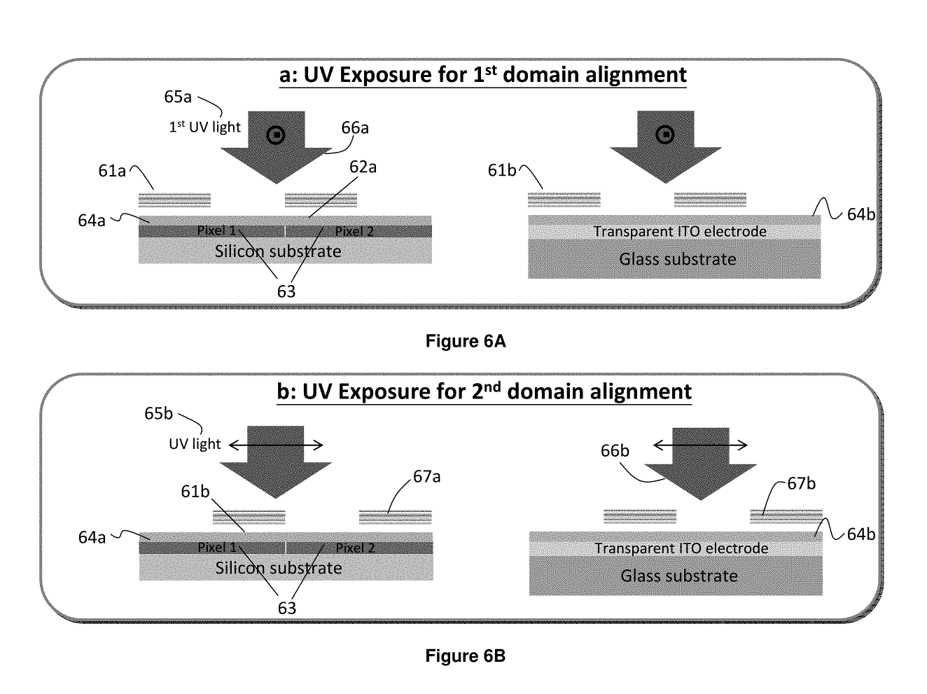

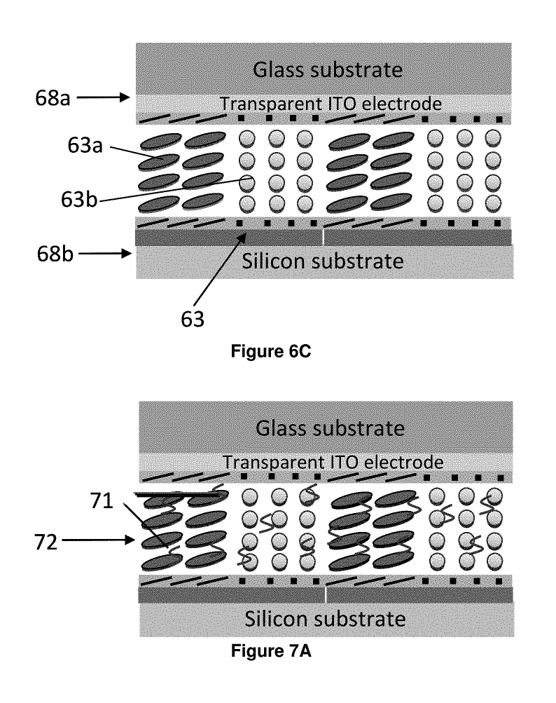

FIGS. 6A-C illustrate a photo alignment process for optically separating one pixel into several sub-pixels for the embodiment of FIG. 5. Similar as FIG. 4A and 4B, a first alignment layer is arranged on the multiple pixel electrodes that are configured above the silicon substrate and a second alignment layer is arranged on the transparent ITO electrode that is configured above the glass substrate. As shown in FIG. 6A, 1st photo masks 61a and 61b are arranged to cover the 1st sub-pixel area 62a of each pixel 63 on both the first alignment layer 64a and second alignment layer 64b. Then a 1st UV light 65a is illuminated on the 1st and 2nd alignment layers 64a and 64b in a perpendicular oriented direction 66a. After that, as shown in FIG. 6B, the 1st photo masks 61a and 61b are taken away, and 2nd photo masks 67a and 67b are arranged to cover the 2nd sub-pixel area 62b of each pixel 63 on both of the first and second alignment layers, 64a and 64b. In one embodiment, the 1st and 2nd sub-pixel areas 62a and 62b are adjacent to each other. Then, a UV light 65b, having the same wavelength as the 1st UV light 65a, is illuminated on the 1st and 2nd alignment layers 64a and 64b in a parallel oriented direction 66b. After the 2nd photo masks 67a and 67b are removed, as shown in FIG. 6C, a silicon substrate portion 68a and a glass substrate portion 68b, formed from the above steps, are assembled to form a phase modulator 69 wherein each pixel 63 is separate into sub-pixels 63a and 63b that are optically isolated to each other due to different alignments of the liquid crystal molecules.

In actual, there are several methods to make the alignment for a phase modulator. In one embodiment, mechanical rubbing could be used to make the alignment layer. However, the produced alignment layer may have scratches and contamination. Furthermore, this method can't realize multi-domain alignment in one pixel. In an alternative embodiment, the present invention could use UV light for photo-alignment as described above. The advantage of photo-alignment is the ease to get sub-micro multi-domain alignment in one pixel. However, thermal stability issue should be solved to satisfy the auto-grade standard.

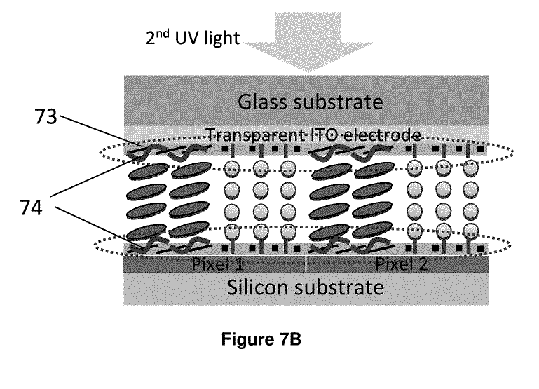

In order to improve the thermal stability of the photo-alignment layer, the polymer network can be penetrated into the liquid crystal layer to strengthen the alignment energy so as to improve alignment layer thermal stability. As shown in FIG. 7A, firstly reactive monomers material 71 are mixed into the liquid crystal layer 72. The monomers material 71 can be RM257, C12A, TMPTA, or NVP. Then, the monomers material 71 polymerizes together to form the polymer material for improve the thermal stability. In one embodiment, monomers' concentration is less than 1 wt %. In FIG. 7B, during the 2nd UV light exposure, monomers such as RM257, C12A, TMPTA, or NVP are polymerized on the alignment surface 73 previously formed under a 1st UV light to form a polymer network 74. The 2nd UV light has different wavelength from that of the 1st UV light.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A phase modulator for a display, comprising:
a liquid crystal layer;
an electrode layer disposed on a first side of the liquid crystal layer for allowing light to pass through; and
a plurality of pixel electrodes disposed on a second side of the liquid crystal layer and being operable with the electrode layer for supplying electric potential across the liquid crystal layer;
wherein on each of the pixel electrodes, the liquid crystal layer comprises at least two domains including a first domain having a first refractive index and a second domain having a second refractive index; and
wherein the first reflective index is different from the second reflective index.

2. The phase modulator of claim 1, wherein the first domain of the liquid crystal layer comprises aligned liquid crystal molecules, and the second domain of the liquid crystal layer comprises non-aligned liquid crystal molecules.

3. The phase modulator of claim 2, further comprising an alignment layer located on the pixel electrodes and/or the electrode layer for forming the aligned liquid crystal molecules.

4. The phase modulator of claim 1, wherein the first domain of the liquid crystal layer comprises aligned liquid crystal molecules having a first orientation, and the second domain of the liquid crystal layer comprises aligned liquid crystal molecules having a second orientation, wherein the first orientation is different from the second orientation.

5. The phase modulator of claim 1, further comprising an alignment layer located between the pixel electrodes and the liquid crystal layer, wherein the alignment layer comprises two different alignment directions on each of the pixel electrodes for forming the first domain of the liquid crystal layer and the second domain of the liquid crystal layer.

6. The phase modulator of claim 1, further comprising an alignment layer located between the electrode layer and the liquid crystal layer, wherein the alignment layer comprises two different alignment directions for forming the first domain of the liquid crystal layer and the second domain of the liquid crystal layer.

7. The phase modulator of claim 1, further comprising a first alignment layer located between the pixel electrodes and the liquid crystal layer, and a second alignment layer located between the electrode layer and the liquid crystal layer, wherein the first alignment layer and the second alignment layer comprise two different alignment directions for forming the first domain of the liquid crystal layer and the second domain of the liquid crystal layer.

8. The phase modulator of claim 1, wherein on each of the pixel electrodes, the liquid crystal layer comprises two of the first domain and two of the second domain, and the first domain is adjacent to the second domain.

9. The phase modulator of claim 1, wherein on each of the pixel electrodes, the liquid crystal layer is divided into four of the first domain by the second domain.

10. The phase modulator of claim 1, further comprising a polymer material penetrated into the liquid crystal layer to improve thermal stability of the liquid crystal layer.

11. The phase modulator of claim 5, further comprising a polymer material enclosing the alignment layer to improve thermal stability of the alignment layer.

12. The phase modulator of claim 6, further comprising a polymer material enclosing the alignment layer to improve thermal stability of the alignment layer.

13. The phase modulator of claim 7, further comprising a polymer material enclosing the first alignment layer and the second alignment layer to improve thermal stability of the first alignment layer and the second alignment layer.

14. The phase modulator of claim 1, wherein the plurality of the pixel electrodes are addressable.

15. The phase modulator of claim 3, wherein the alignment layer for forming the aligned liquid crystal molecules is formed by steps of:
coating photo-sensitive alignment material on each of the pixel electrodes;
placing a photo mask on the alignment material; and
illuminating the alignment material with UV light without shielding by the photo mask to form the alignment layer.

16. The phase modulator of claim 5, wherein the alignment layer comprising two different alignment directions is formed by steps of:
coating photo-sensitive alignment material on each of the pixel electrodes;
placing a first photo mask on the alignment material;
illuminating a first part of the alignment material with light having a first polarized direction, wherein the first part of the alignment material is not shielded by the first photo mask;
placing a second photo mask on the alignment material; and
illuminating a second part of the alignment material with light having a second polarized direction to form the alignment layer comprising two different alignment directions, wherein the second part of the alignment material is not shielded by the second photo mask.

17. The phase modulator of claim 5, wherein the alignment layer is formed by steps of:
coating photo-sensitive alignment material on each pixel electrode;
placing a photo mask on the alignment material;
illuminating a part of the alignment material with light, wherein the part of the alignment material is not shielded by the photo mask;
forming the alignment layer from the alignment material after light illumination;
illuminating the second part of the pixel electrode with a first wavelength UV light;
filling in the liquid crystal layer between the opposing electrodes, the liquid crystal layer including liquid molecules, and monomers; and
polymerizing the monomers with a second wavelength UV light.
